(19) United States
(12) Patent Application Publication
(10) Pub. No.: US 2021/0105934 A1
(43) Pub. Date: Apr. 15, 2021

(54) Mobile Aqueous Chemical Injection And Application Apparatus

(71) Applicant: Seth Inman, Bloomington, IN (US)

(72) Inventor: Seth Inman, Bloomington, IN (US)

(21) Appl. No.: 17/069,811

(22) Filed: Oct. 13, 2020

Related U.S. Application Data
(60) Provisional application No. 62/913,872, filed on Oct. 11, 2019.

(51) Int. Cl. A01C 23/04; B01F 5/04; B01F 15/00; B01F 15/02; B01F 13/00; A01G 25/16; A01G 25/09; A01M 7/00; A01M 21/04; A01C 23/00

(52) U.S. Cl. CPC A01C 23/042; B01F 5/0413; B01F 15/00149; B01F 15/026; B01F 15/0248; B01F 13/002; B01F 2215/0055; A01G 25/09; A01M 7/0042; A01M 21/043; A01C 23/007; A01C 23/047; A01G 25/16

(57) ABSTRACT

This invention is a mobile water and chemical delivery system that allows for the injection of a chemical in the path of the water line under high pressure. The system allows for mobile agricultural workers to move large quantities of clean water between job sites to use to deliver agricultural chemicals inline without having to carry large quantities of chemicals into the field. The chemicals are injected between the mobile water tank and the hoses that take the water from the tank to the application site. The purity of the mobile water source remains constant even if there is a change in the chemical.

### BACKGROUND OF THE INVENTION

The present invention is in the technical field of devices and methods related to the fertigation of gardens, lawns, trees, and fields.

The delivery of water soluble chemicals with water allows for a better distribution of the chemicals over the ground and into the soil. When the chemical is a fertilizer this process is known as fertigation. This type of distribution allows for a smaller amount of chemicals/nutrients to be applied over a larger area. So, with this method there is a more even distribution of the chemical and there's also a better penetration of the chemicals into the soil. The chemical may be a fertilizer insecticide or other chemical which is helpful for the growth of plants, such as plant nutrients and insect control materials. One of the limitations of current designs is that they rely on a very tight connection with a threaded bolt on holes intended for mounting the wheel assembly with nuts attached to alternate sides of the board. Sometimes this process requires a small enlargement of the wheel assembly holes to fit the plug or the bolt.

Chemical injection devices can work either on piston flow (positive displacement pumps) or on vacuum generation (suction or negative pressure, Venturi type) principals. A venturi pump can generate a continuous flow of a mixed water/chemical solution if the chemical is water soluble. Pressurized water applied to the input end of this device will generate a pressure differential from the input end to the output end and cause a suction at the T-joint of the device. There are other more complicated Venturi systems that could also be used which also generate a pressure differential but have pass arounds and more valves. The more complicated Venturi systems still work on the same principles of generating a pressure differential across a system.

Because a water source is not always accessible for mobile grounds keepers/agricultural workers it is often necessary to fill a large tank with water and transport it to a work site with all needed equipment on the back of a truck, trailer hitch or use a tank truck full of water. If an agricultural treatment calls for a treatment of chemicals mixed with water, it is mixed in the tank based on the treatment that is called for. The typical procedure calls for workers to add the chemicals to be mixed in with water based on the amount of chemical needed for a certain area of land, the requirements of the plants in the area and the amount of water that is required to transfer the chemicals. This procedure can be repeated until a different chemical mixture is needed. If the prior chemicals and new chemicals are incompatible then the tank will need to be emptied and cleaned, with the residue of the prior chemicals properly disposed of.

The workers that would use this type of equipment/procedure range from agricultural workers to arborists. Depending on the employer the educational requirements can range from a high school degree to an associate degree in arboriculture, or agriculture. A license is also required to apply pesticides.

Some chemicals can be dispensed using a clean water source and a handheld Chemical infuser. This handheld infuser generally contains a small amount of the chemical which is mixed at the end of the hose. The water source is pumped out through hoses to the target area using this method gives a precise treatment of a small target area.

### SUMMARY OF THE INVENTION

This invention is an assembly of parts in a mobile water and chemical delivery system that allows for the injection of a chemical in the path of the water line under high pressure. The assembly of parts comprises: a mobile water source preferably a large tank of clean water; a pump capable of delivering the water at high-pressure; means for measuring the pressure change at a venturi pump, check valves to prevent the back flow of chemicals into a clean water source, an adjustable flow meter, and a hose or hose reel to take the water from the injection site where the water/chemicals are needed.

The invention is also a method of measuring and mixing a chemical and water for agricultural needs to apply larger qualities of chemicals without compromising the purity of the mobile water source using a venturi pump with a flow meter and metering valve to accurately generate a precise ratio of chemical to water.

### BRIEF DESCRIPTION OF THE DRAWINGS

FIG. 1 is a diagram of a simple Venturi pump.

FIG. 2 is a flow chart showing the preferred order of elements in a water and chemical delivery system.

FIG. 3 is a parts diagram of a mobile system for inline mixing of chemicals and water.

FIG. 4 is a top view; and

FIG. 5 is a cut view of a venturi pump device.

### DETAILED DESCRIPTION OF THE INVENTION

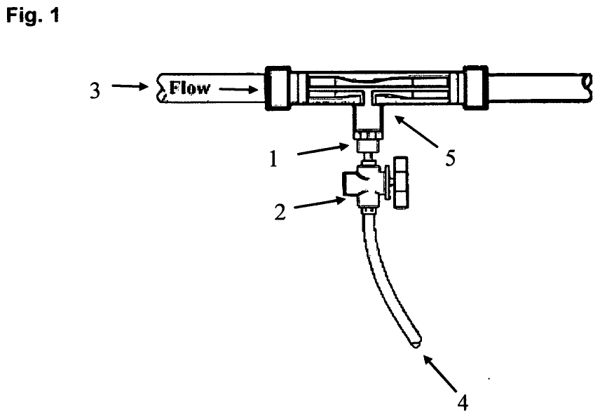

Referring now to the invention in more detail, in FIG. 1 there is shown an example of this type of chemical injector. A preferred embodiment of this invention includes a venturi pump (5) with a flow meter and a metering valve (2) as a means of injecting and mixing a concentrated water-soluble chemical (4) with a stream of clean water (3) wherein the flow of the chemical is modified by venturi pump (5) (or the pressure drop), the metering valve (2), and the check valve. This chemical injector features the optional check valve (1) the metering valve (2), and a source of a concentrated water-soluble chemical prior to metering valves. A flowmeter is often combined with the metering valve.

Referring now to the invention in more detail in FIG. 2 there is shown in flow chart style the preferred embodiment. Water and chemicals flow in the direction of the arrows. Clean water is defined to be a source of water that is not dangerous to the environment and can be released back into the environment in a manner similar to a highly purified water source. In the preferred embodiment, the portable clean water is typically contained in a 200 gallon tank mounted on a truck or trailer. If the portable water tank (6) is a tanker truck the volume will be much bigger. The water pump (7) is a 4 stroke gas engine, or another pump system capable of generating a pressure of about 200 psi into a ½ inch supply hose. After the pump there is a cutoff valve (8) that acts as an optional diverter valve. The cutoff valve (8) can deliver water without any additives to a hose (9) for watering or a mixing of additives at the end of the hose with a handheld mixer, or an applicator (10). The water at the alternate applicator (10) is about the same as at the pump outlet. The cutoff valve (8) may also pass water toward the venturi pump (14). The pressure gauge (11), the check valve (12), and the optional cut off valve (13) can be placed in between the cutoff valves and the venturi pump (14). The order of elements (11), (12), and (13) are not important to the functionality of the assembly. A pressure gauge can be important for the assembly when a pump has a variable pressure output. An additional pressure gauge (15) can be installed after the venturi pump and before the hose/hose reel (16), and the primary applicator (17).

Further referring to the invention in more detail, FIG. 2 shows the preferred order of the elements. A filtered inlet (18) allows for a venturi pump (14) to inject water soluble chemicals into water from a container that may have some larger particles. A flowmeter with a metering valve can be placed on the chemical inlet for the venturi pump (14). The water stream is pressurized to about 120+−20 psi between the water pump (7) and the venturi pump (14). The system induces a pressure drop of about 40 psi at the venturi pump. A simple system like the one shown in FIG. 1 is preferred, but other more complex systems are possible.

Further referring to the invention in more detail the device of FIG. 2 can be installed horizontally but optimal performance position is vertical with the water flowing up from the first pressure gauge (11) through the venturi pump (14) to the second pressure gauge (15). The optimal model will be compatible with spray equipment that uses ½″ supply hose and ¾″ fittings. However, other sizes of hose can be used. The optimal venturi pump requires 120 psi inlet pressure with a 30 psi pressure drop across the device. The flowmeter for the Venturi suction tube can adjust the product infusion from 2 to 6 oz of concentrate per gallon, or more. After concentrate is added to the main line a check valve keeps it from contaminating any of the pure water source. At the end of the hose reel you can use a spray gun or deep root feeder to deliver the product.

Larger and smaller versions can be designed based on an array of factors: pressure, weight of concentrate, required oz per gal, hose size, etc. This can be achieved by replacing the venturi size to accommodate specific needs.

Clean water flows past the first pressure gauge (11). It then passes through the check valve (12) to a ball valve (13). Once the cutoff valve (13) is opened the second pressure gauge is activated along with the venturi pump (14). The venturi pump (14) has a suction tube with a filter at one end that is placed into the chemical source (18) with the desired product. This suction tube also has a flowmeter (18) to inspect rate of product injection with the water supply. This rate of uptake can be adjusted with the metering valve (19). The injection of chemicals into the stream of pure water begins once the pressure is released at the end of the supply line by pulling the trigger/handle of the primary applicator (17) whether a handheld sprayer or deep root feeder, or other means for the application of water. The venturi pump (14) will not siphon if the handle of the primary applicator (17) is not pulled. The check valve (12) prevents backflow to the water tank.

The advantages of the present invention include, without limitation with this assembly the clean water source remains clean over multiple uses. The usual procedure for lawn maintenance/tree health specialists is to mix chemicals in the water tank. When a new chemical is needed the tank is cleaned and any leftover product and residue is properly disposed of. The injection and mixing of a chemical solution into a larger amount of water is helpful in aiding the even distribution of the mixture into the soil and down to the roots. The chemical can be a fertilizer insecticide or other material which is helpful for the growth of plants. This change in procedure, and equipment should result in a reduction in the risk of applicator exposure, large product spills, and/or unauthorized dumping of unwanted water chemical mixtures. The inline mixing allows the user to switch between products freely.

The advantages of the invention further include, without limitation, a filter that prevents any large particles in the chemical container from entering the pump. The container of chemicals is not required to be integrated into the system and can be any container that is resistant to the chemical needed. As a double check on the flow meter a graduated container with a set amount of fluid can be substituted for the chemical source when the system is running in combination with a timer. The displacement of that fluid over time versus the output at the secondary applicator verifies the ratio of chemical to water.

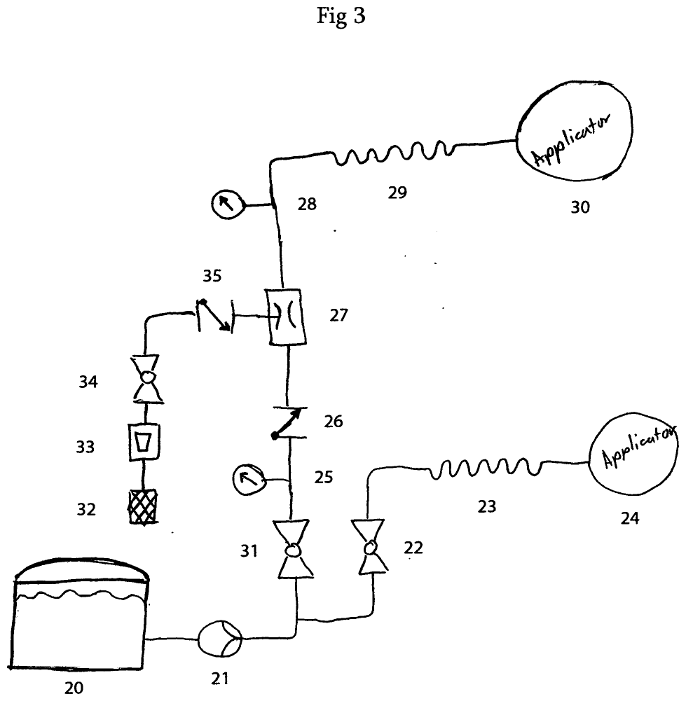

Referring now to the invention in more detail, FIG. 3 shows a diagram of the apparatus with an alternate applicator (24) that bypasses the injection of chemicals prior to the application. A portable tank of pure water (20) is connected to a water pump (21) that comprises: a piston pump. A cutoff valve (31) comprising: a ball valve controls the pressure on or flow through the venturi pump. The first pressure gauge (25) and the second pressure gauge (28) can be used to determine the water pressure before and after the venturi pump (27). A check valve (26) prevents contamination of the pure water source (20). The venturi pump (27) causes a specific pressure drop (for example 120 to 80 psi) to inject a chemical with flow rates in the range of about 1 to 5 gallons per hour. The metering valve (34) comprises: a ball valve used to modify the flow rate of the chemicals. The metering valve (34) is often built into the flow meter (33) and is used to adjust the flow rate to the prescribed reading. The flow meter (33) comprises: a floating ball; or a variable area flow meter. The filter (32) can be placed in a container of the concentrated water soluble chemicals and will prevent the uptake of any small particles that could clog the venturi pump (27).

The hose or hose reel (29, 23) carry the water to the applicator (30, 24) once the applicator is activated the water starts to flow into the system. The flow of water causes the injection of the chemicals into the system. The primary applicator (30) and the alternate applicator (24) The flow rate is verified on the flow meter (33) and adjusted with the metering valve (34).

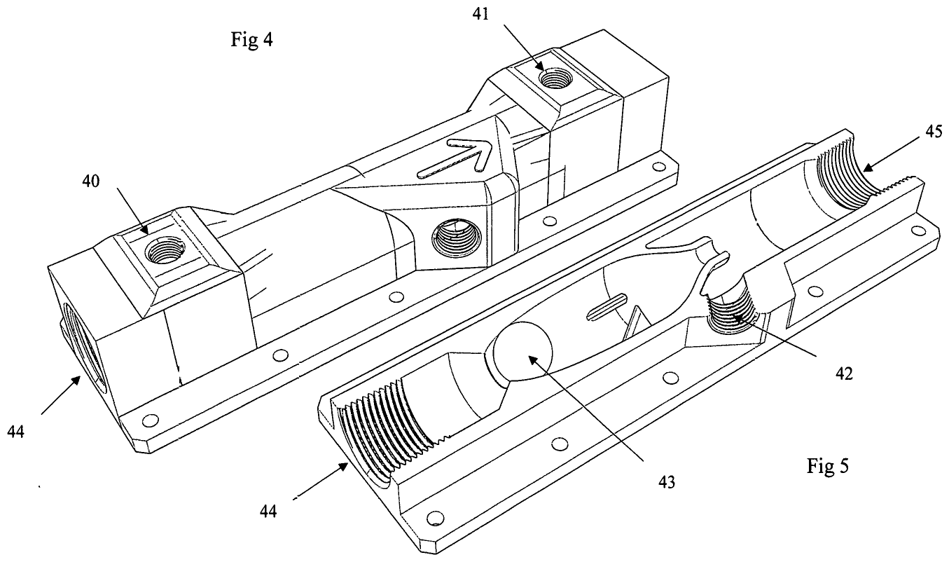

Referring now to the invention in more detail FIG. 4 and FIG. 5 respectively show a perspective and cutaway view of an inline mixing device. This device can be bolted onto a trailer or the back of the vehicle carrying the portable water source with the arrow pointing up and with the intended flow of water. A water inlet (44) is shown on the bottom with a ⅜ NPT junction. A water outlet (45) is shown on the top side with a ¾ NPT junction. Inside the device near the water inlet (45) is an integrated check valve (43). Near the mix outlet (45) is the mixing chamber (46) with a flow restrictor (47) that generates the low pressure to draw in chemical product from a chemical product inlet (42). The chemical product inlet (42) is shown with a ¼ NPT junction.

Further referring to the invention in FIG. 4 and FIG. 5, the device is used in a manner similar to that seen in FIG. 2, and FIG. 3. To get higher pressure of pure water at the applicator the system is built to be simple to remove or bypass. To remove the invention in FIG. 4 a set of quick-change fittings for the water inlet and mix outlet can be used. To bypass the venturi pump a valve can be used like seen in FIG. 3 or a more complicated venturi system can be used that has a bypass hose and pure water returns at pump pressure returns to the primary applicator. The chemical source is a water soluble concentrate, or aqueous mix of a water soluble powder when a filter is used to prevent small particles from entering the pump through the chemical product inlet (42). The flowmeter can be a simple floating ball flowmeter or can be a simple measure of fluid displacement. The chemical source is a simple filter placed in a container of water soluble agricultural chemicals.

In broad embodiment, the present invention is an apparatus comprising: a tank of water that can be transported from jobsite to jobsite; a pump to pressurize the water to specific pressure; a check valve; a venturi pump with an agricultural chemical/water mixing chamber attached near the tank; and a metering valve or a method of controlling the rate of volume of chemical entering the venturi pump.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. An apparatus for the storage, in-line mixing and dispensing of water and agricultural chemicals comprising the following elements:
at least one source of portable water wherein the source is a container of clean water that is easily moved comprising, a large water tank or a truck bed container;
a primary pump connected to the clean water source, wherein the pump provides an average pressure such that the system gives adequate flow to perform either deep root feeding, or surface irrigation with the proper attachment;
a mixing pump that pulls chemical concentrate into the apparatus;
a set of check valves that prevent back flow to the pure water source;
a hose, or hose reel that connects the venturi pump to an applicator system where in the applicator system can be a deep root feeder, or a surface irrigation system; and
a flowmeter and a metering valve connected to the venturi pump and the chemical source.

2. The apparatus of claim one such that the mixing pump comprises a venturi pump.

3. The apparatus of claim one such that the Chemical source is a filter that inserts into a container of water-soluble chemical concentrate.

4. The apparatus of claim one such that check valves are placed between the pump and the venturi pump, and also between the venturi pump and the chemical source.

5. The apparatus of claim one such that the flow meter, a metering valve, and the check valve are integrated together.

6. The apparatus of claim one such that the primary pump is a positive displacement pump, or a centrifugal water pump.

7. The apparatus of claim 1 such that the positive displacement pump comprises, a piston pump or a plunger pump.

8. The apparatus of claim 1 further comprising, a valve between the primary pump and the mixing pump that selects whether the pure water is directed to the mixing pump or directly to the applicator via a hose or hose reel.

9. The apparatus of claim 1 further comprising, a set of cutoff valves that can either relieve the pressure to the system, or bypass the venturi pump leading to either a second hose or hose reel and applicator or back to the hose or hose reel associated with the venturi pump and applicator.

10. The apparatus of claim 8 wherein the applicator is a hand held chemical mixing system.

11. A method of irrigation comprising:
the transport of a container of pure water on the back of a vehicle or vehicle trailer to a site that needs treatment with a chemical, water mixture;
pressurization of the pure water with a pump;
mixing the pure water in an inline mixing system which is attached or in close proximity to the truck or trailer carrying the container of pure water, with an agricultural chemical, wherein the inline mixing system comprises: a venturi pump; a mixing chamber, and a check valve;
transport of the mixed water chemical solution from the container of pure water to the application site via a hose or hose reel; and
application of the mixed water chemical solution via a sprayer, or a deep root feeder.

12. The method of claim 10 wherein the agricultural chemical comprises one or more of the following chemicals, a fertilizer, an insecticide, an herbicide, a root treatment or a gas.

13. The method of claim 10 wherein the inline mixing system further comprises:
a filtered inlet in a large container of concentrated water soluble chemicals; and
a flowmeter with a metering valve and a check valve.

14. The method of claim 10 wherein the venturi pump further comprises a system with 1 or more hoses that bypass the inline mixing system.

15. An inline mixing device attached near a portable tank of pure water comprising:
a hose inlet;
a check valve;
a venturi pump with mixing chamber and a small hose port for agricultural chemicals;
a first pressure gauge before the venturi pump;
a second pressure gauge after the venturi pump; and
a hose outlet.

16. The inline mixing device of claim 16 further comprising:
a flow meter with an integrated metering valve connected to the small hose port; and
a filter for small suspended chemical particles also connected to the small hose port.

17. The inline mixing device of claim 16 wherein the inline mixing device and the tank of pure water is attached to the back of a small truck, or a trailer following the small truck.

18. The inline mixing device of claim 16 wherein the hose inlet and hose outlet are fitted with quick change adapters for fast removal and reinstallation.

19. The inline mixing device of claim 16 further comprising;
a set of valves that are configured to bypass the venturi pump directing pure water to an applicator at a pressure that is the same as at a water pump near the tank of pure water.
